(19) United States
(12) Patent Application Publication
(10) Pub. No.: US 2011/0253107 A1
(43) Pub. Date: Oct. 20, 2011

(54) METHOD AND SYSTEM FOR INJECTING FUEL INTO INTERNAL COMBUSTION ENGINES

(76) Inventors: Michael Gebhard, Stegaurach (DE); Peter Cromme, Bamberg (DE); Friedrich Boecking, Stuttgart (DE); Claudia Klotz, Memmelsdorf (DE); Thomas Pauer, Freiberg (DE); Helmut Sommariva, Graz (AT)

(21) Appl. No.: 13/141,776

(22) PCT Filed: Oct. 28, 2009
(86) PCT No.: PCT/EP09/64204

§ 371 Date: Jun. 23, 2011

(30) Foreign Application Priority Data
Dec. 23, 2008 (DE) 10 2008 055 136.8

(51) Int. Cl. F02M 55/02

(52) U.S. Cl. 123/468

(57) ABSTRACT

The invention relates to a method and to a system for injecting fuel into internal combustion engines, the injection taking place by way of an injection system and the fuel to be injected having an increased amount of fatty acids or fatty acid esters, particularly biodiesel. According to the invention, the components of the injection system coming into contact with the fuel are at least partially provided with a coating that has a low tendency for the agglomeration of fuel components, particularly fatty acids and fatty acid esters.

### PRIOR ART

The invention relates to a method for injecting fuel into internal combustion engines as generically defined by the preamble to claim 1 and to a system for injecting fuel into internal combustion engines as generically defined by the preamble to claim 8.

As a consequence of the use of biofuels, the proportion of fatty acid or fatty acid ester in the fuel is elevated in comparison with mineral fuel. If these components of the biofuel come into contact with metal surfaces of the injection system, deposits form, which grow continuously. With a rising proportion of biofuel in the fuel, the danger of failure of functionally relevant components of the injection system increases.

### OBJECT OF THE INVENTION

It is the object of the present invention to propose a method and an injection system which avoids or reduces the interfering deposits, particularly on functionally relevant components, when biofuels are used.

### DISCLOSURE OF THE INVENTION

The object of the invention is attained with the definitive characteristics of the bodies of claim 1 and claim 8, respectively.

### EXEMPLARY EMBODIMENTS

Exemplary embodiments of the invention are described further detail in the ensuing description.

The invention describes a method and an apparatus for improving the reliability of existing as well as future injection systems when biofuels are used, especially biodiesel or fuels containing biodiesel. In existing injection systems, in particular a diesel common rail system, biodiesels that are aged or have a high water content lead in particular to deposits in such functionally relevant components as valves, valve members, valve seats, valve tappets, nozzle, nozzle needle, polygonal rings, eccentric rings, pistons, cup tappets, roller supports, rollers, etc. The deposits are essentially due to adsorption (physical adsorption and/or chemical adsorption) of the fatty acids or fatty acid esters present in the biodiesel and ensuing polymerization reaction of the fatty acids or fatty acid esters with components of the biodiesel, which leads to a continuing growth of the deposits. A prerequisite for the adsorption of fatty acids and fatty acid esters is metallic or ionic bonds at the surface, with which so-called chelating complexes are formed.

The nucleus of the invention is a coating of the critical parts of the components of the injection system, such as the pump or injector, with a thin film at which fatty acids and fatty acid esters can no longer be adsorbed. Suitable thin films must furthermore have a very high chemical resistance to biodiesel and mineral diesel.

According to the invention, the adsorption of fatty acids and fatty acid esters is avoided by means of a surface modification. In the ideal case, a thin film, a few atoms thick, of a material that has covalent bonds is sufficient. Fatty acids and fatty acid cannot form chelating complexes on covalent surfaces, and as a consequence, long-term adsorption of these compounds on the surface can no longer occur, either. A suitable thin film ust furthermore have a very high resistance to biodiesel or mineral diesel. Suitable materials for such a thin film include above all nitrides, carbides (including nonstoichiometric compounds), and mixed forms of the two, such as silicon nitride, titanium nitride, titanium carbide, etc. Layers of carbon are also suitable, especially DIE (diamond-like carbon) films and diamond films. In principle, oxidic systems such as SiOₓ, organic thin films, or organic monolayers (SAMs, self assembled monolayers) are also suitable as a protective layer to prevent the adsorption of fatty acids and fatty acid esters. Many of the thin-film variants can be applied in a simple way by means of PECVD (Plasma Enhanced Chemical Vapor Deposition), PVD (Physical Vapor Deposition), CVD (Chemical Vapor Deposition), sputtering, etc.

A further possibility for forming suitable coatings comprises producing C-films of carbon. Because of the C-film, the fuel can be prevented from coming into direct contact with a metal surface. In contrast to the already-known application of C-coatings in which the application is done only to the part of a pair of components that has the greater tendency to wearing, the C-coating according to the invention is applied to both component partners that are movable relative to one another and cooperate with one another, such as a roller support and roller, a polygonal ring and cup, an eccentric ring and piston, a nozzle needle and nozzle, and a valve member and valve seat.

Furthermore, the possibility exists of utilizing the chelating process actively for applying a durable protective layer, in that the threatened components of the injection system, before they come into contact with the biofuel that contains fatty acid or fatty acid ester, are operated with a fuel which, while it does adhere to metal surfaces of the components by way of the chelating process, nevertheless itself has no C—C double bonds and thus prevents the formation of a film by the biofuel. The protective layer must be sufficiently resistant to abrasion from the biofuel or mineral fuel used later. Hence the scavenging fuel forming the protective layer should preferably be a synthetic fuel of appropriate purity, preferably a single-component fuel, that has no C—C double hands and no covalent bonds on the free surface of the protective layer.

1-13. (canceled)

14. A method for injecting fuel into internal combustion engines, in which the injection is effected via an injection system and the fuel to be injected contains an elevated proportion of fatty acid or fatty acid esters, especially biodiesel, comprising the step of:
at least partially providing components of the injection system that come into contact with the fuel with a coating which has a low tendency to accumulation of fuel components, and in particular, to adsorption of fatty acids and fatty acid esters.

15. The method as defined by claim 14, wherein the coating on its surface comprises a material of metal which has covalent bonds.

16. The method as defined by claim 15, wherein the material contains nitride, carbide, or a mixed form, such as silicon nitride, titanium nitride, or titanium carbide.

17. The method as defined by claim 14, wherein the coating comprises carbon, DLC (diamond-like carbon), diamond, or an oxide, such as SiOₓ.

18. The method as defined by claim 14, wherein the coating is applied by means of PECVD, PVD, CVD, or sputtering.

19. The method as defined by claim 15, wherein the coating is applied by means of PECVD, PVD, CVD, or sputtering.

20. The method as defined by claim 16, wherein the coating is applied by means of PECVD, PVD, CVD, or sputtering.

21. The method as defined by claim 17, wherein the coating is applied by means of PECVD, PVD, CVD, or sputtering.

22. The method as defined by claim 14, wherein components of the injection system, before normal operation begins, are operated with a fuel which adheres to metal components, but does not have C—C double bonds.

23. The method as defined by claim 15, wherein components of the injection system, before normal operation begins, are operated with a fuel which adheres to metal components, but does not have C—C double bonds.

24. The method as defined by claim 22, wherein the fuel is produced synthetically and preferably is a single-component fuel of corresponding purity.

25. The method as defined by claim 23, wherein the fuel is produced synthetically and preferably is a single-component fuel of corresponding purity.

26. A system systeuo for injecting fuel into internal combustion engines, in which the injection is effected via an injection system and the fuel to be injected contains an elevated proportion of fatty acid or fatty acid esters, especially biodiesel, and in which components of the injection system that come into contact with the fuel at least partially coated with a coating which has a low tendency to the accumulation of fuel components, and in particular, to adsorption of fatty acids and fatty acid esters.

27. The system as defined by claim 26, wherein the coated components are each cooperating parts movable relative to one another, such as a roller support and roller, a polygonal ring and cup, an eccentric ring and piston, a nozzle needle and nozzle, and a valve member and valve seat, and in each case both partner parts are provided with the coating.

28. The system as defined by claim 26, wherein the coating on its surface comprises a material of metal which has covalent bonds.

29. The system as defined by claim 27, wherein the coating on its surface comprises a material of metal which has covalent bonds.

30. The system as defined by claim 28, wherein the material contains nitride, carbide, or a mixed form, such as silicon nitride, titanium nitride, or titanium carbide.

31. The system as defined by claim 29, wherein the material contains nitride, carbide, or a mixed form, such as silicon nitride, titanium nitride, or titanium carbide.

32. The system as defined by claim 26, wherein the coating comprises carbon, DLC (diamond-like carbon), diamond, or an oxide, such as SiOₓ.

33. The system as defined by claim 26, wherein the coating is applied by means of PECVD, PVD, CVD, or sputtering.
